(19) United States
(12) Patent Application Publication
(10) Pub. No.: US 2010/0268593 A1
(43) Pub. Date: Oct. 21, 2010

(54) SYSTEM AND METHOD FOR CREATING COUPON OFFERS AND BARCODES

(76) Inventors: Ravi Keswani, Fremont, CA (US); Bingwu Li, Sunnyvale, CA (US); Manickababu Muthugopalakrishnan, Fremont, CA (US); Junlong Zhao, Sunnyvale, CA (US); Robert Michael Gonzales, San Francisco, CA (US); Brian Parrish Hamachek, Palo Alto, CA (US); Emmanuel R. Pilli, San Bruno, CA (US); Jane Michels, Bloomington, IN (US); Brian T. Tickler, Santa Clara, CA (US)

Correspondence Address: HICKMAN PALERMO TRUONG & BECKER, LLP, 2055 GATEWAY PLACE, SUITE 550, SAN JOSE, CA, 95110, US

(21) Appl. No.: 12/427,711

(22) Filed: Apr. 21, 2009

(51) Int. Cl. G06Q 30/00

(52) U.S. Cl. 705/14.38; 705/14.39; 705/14.1

(57) ABSTRACT

A system or method that enables the user to create a coupon offer by selecting a barcode type for a coupon offer. In response to the user's selection, the user is presented with an interface that is specific to the selected barcode type. The interface includes one or more fields that notify or guide the user in providing necessary information to be carried on the barcode of the coupon offer.

### TECHNICAL FIELD

Embodiments described herein relate to a system and method for creating coupon offers and barcodes.

### BACKGROUND

Coupons and other similar transactional instruments are generally structured and formatted in compliance with one of the industry or published standards for coupons. A typical coupon (print form) includes a barcode that can be scanned and validated by a retailer at point of sale. Among other challenges, manufacturers and other suppliers of coupons must generate coupons that are properly coded and formatted. Considerations involved in creating coupons include generating the coupon's barcode so that it can be machine-scanned at point of sale to identify the correct value and be associated with the desired product. To identify the correct products, coupons include a family code (often a 3-digit code set by a standard) that identifies a particular product or product group.

An improperly constructed barcode on a coupon is problematic for both the coupon manufacturer and the retailer. For example, if the barcode does not identify the same products represented on the coupon's image (in human readable form), the retailer may be forced to either honor an invalid coupon or turn the customer away. As another example, if the manufacturer creates a barcode that misidentifies the product, the manufacturer may unwillingly grant discounts to the wrong product(s).

As mentioned, the barcode on coupons is typically standardized. One standardized barcode format is UPC.Version A which has the following format:

### 5 MMMMM FFFVV c

In this format, the first digit(s) are either the number five (5) or the number ninety-nine (99). This number identifies the barcode as a coupon to the point-of-sale (POS) machine/logic. The second set of digits is comprised of a five-digit manufacturer identification number. In most cases, this number must match the manufacturer identification number of the item being discounted by the coupon. This is shown as MMMMM above. The next three (3) digits is a family code, summary code or super summary code. This number is determined by a manufacturer and is based on how the manufacturer is offering the coupon. The family code hierarchy of the coupon is predetermined by a manufacturer and used so that a coupon can only be redeemed for those items associated with the manufacturer ID and family code of the coupon. In the depicted format, the next two (2) digits are a value code. This is taken from a predetermined listing, published by GS1 (formerly the Uniform Code Council). The final digit is a check character that is calculated from the previous eleven (11) digits, shown as c above.

Another type of barcode is a UCC/EAN-128 Coupon Extended code. There are five formats available for use. These formats include application identifiers and data that may or may not include information such as Number System Character (NSC or the first digit of the manufacturer identification number), a five (5) digit offer code, a four (4) digit expiry date, and an eight (8) digit identification number.

Coupons carry family codes which match to the family code of products. In a typical transaction, the coupons are scanned at the end of the customer's transaction. For a UPC type coupon, point-of-sale machine/logic identifies the number five (5) or ninety-nine (99) at the beginning of the coupon barcode. The presence of this number enables the machine to determination that the scanned item is a coupon. The machine/logic reads the barcode on the coupon, and compares the information of the barcode with the stored information in the retailer's product file. Typically, the machine/logic checks the items purchased by the customer in order to identify an item with that same manufacturer ID number that is within the barcode symbol on the coupon. If product(s) with the same manufacturer ID exist in the purchase, the machine logic checks to see if the family code of the coupon accommodates the product identifier of the items purchased. If there is a match, the value of the coupon is deducted from the customer's order. If there is no match, the machine/logic generates an error code.

### BRIEF DESCRIPTION OF THE DRAWINGS

FIG. 1 illustrates a system for enabling the creation and efficient use of coupons or other transactional instruments, by both manufacturers and retailers, according to one or more embodiments.

FIG. 2 illustrates the use of offer creation module, under an embodiment.

FIG. 3 illustrates a method for creating coupon offers, under an embodiment.

FIG. 4A illustrates a presentation in which a user is enabled to create offers, under an embodiment.

FIG. 4B through FIG. 4E illustrate interfaces for the user to enter barcode information (corresponding to the user's coupon offer) for different kinds of barcodes, according to one or more embodiments.

FIG. 5 illustrates a method for generating such a recommended family code, under an embodiment.

FIG. 6 illustrates a presentation in which a recommended family code is suggested to the user, such as described with an embodiment of FIG. 5.

FIG. 7A through FIG. 7E illustrate various interfaces that may be generated from a system such as described with FIG. 1, under an embodiment.

FIG. 8 illustrates an analyzer module (see FIG. 1) for providing retail service functionality using coupon/product information maintained in the data store system, under another embodiment.

FIG. 9 illustrates a coupon record that may be generated as a result of a retail service provided with a system of FIG. 1, under another embodiment.

### DETAILED DESCRIPTION

According to one or more embodiments, a system is provided to enable a manufacturer (or other user) to create and manage coupon offers and their respective barcodes. According to an embodiment, a system includes one or more modules that operate to enable the user (or the “manufacturer” or coupon supplier) to select a barcode type for a coupon offer. On selection of the barcode type, an interface is displayed to the user that is specific to the barcode type. The interface includes one or more fields that guide the user to provide one or more inputs. Data is generated to create a barcode of the selected barcode type, using information that is determined from the user.

According to another embodiment, a method is provided in which a user selects a barcode type from a plurality of barcode types. In response to the user's selection, the user is presented with an interface that is specific to the selected barcode type. The interface includes one or more fields that prompt (or notify) the user to provide information, in accordance with the structure and format of the selected barcode type. Data for the barcode is generated for the user's coupon offer. The data is generated to match the format of the selected barcode type. The barcode data is generated using information that is provided by the user interacting with the interface(s).

In general, consumers present coupon offers as ‘coupons’ to a retailer. Traditionally, coupons can be printed and/or distributed via free-standing-inserts (FSIs), magazines, newspapers, direct mail flyers, in-store advertisements, attached to or inserted into a package or any other number of vehicles. However, coupons can also be distributed via a network (e.g. Internet) to consumer devices, to enable consumers to redeem or otherwise use the coupons. More specifically, coupons (with barcode and images) may be distributed, or otherwise made available for printing or use by consumers on devices that are operated by the consumers (e.g. user computer and printer). Coupons may also be made available for print and/or use to consumers at other locations, such as at kiosks or other retail outlets.

One or more embodiments described herein provide that methods, techniques and actions performed by a computing device are performed programmatically, or as a computer-implemented method. Programmatically means through the use of code, or computer-executable instructions. A programmatically performed step may or may not be automatic.

Any of the embodiments described herein may be implemented using modules. A module may include a program, a subroutine, a portion of a program, or a software component or a hardware component capable of performing one or more stated tasks or functions. As used herein, a module can exist on a hardware component independently of other modules, or a module can be a shared element or process of other modules, programs or machines.

Furthermore, any embodiments described herein may be implemented through the use of instructions that are executable by one or more processors. These instructions may be carried on a computer-readable medium. Machines or modules shown in figures provided herein include examples of processing resources and computer-readable mediums on which instructions for implementing embodiments of the invention can be carried and/or executed. Examples of computer-readable mediums include permanent memory storage devices, such as hard drives on personal computers or servers. Other examples of computer storage mediums include portable storage units, such as CD or DVD units, flash memory (such as carried on many cell phones and personal digital assistants (PDAs)), and magnetic memory. Computers, terminals, network enabled devices (e.g. mobile devices such as cell phones) are all examples of machines and devices that utilize processors, memory, and instructions stored on computer-readable mediums.

System Description

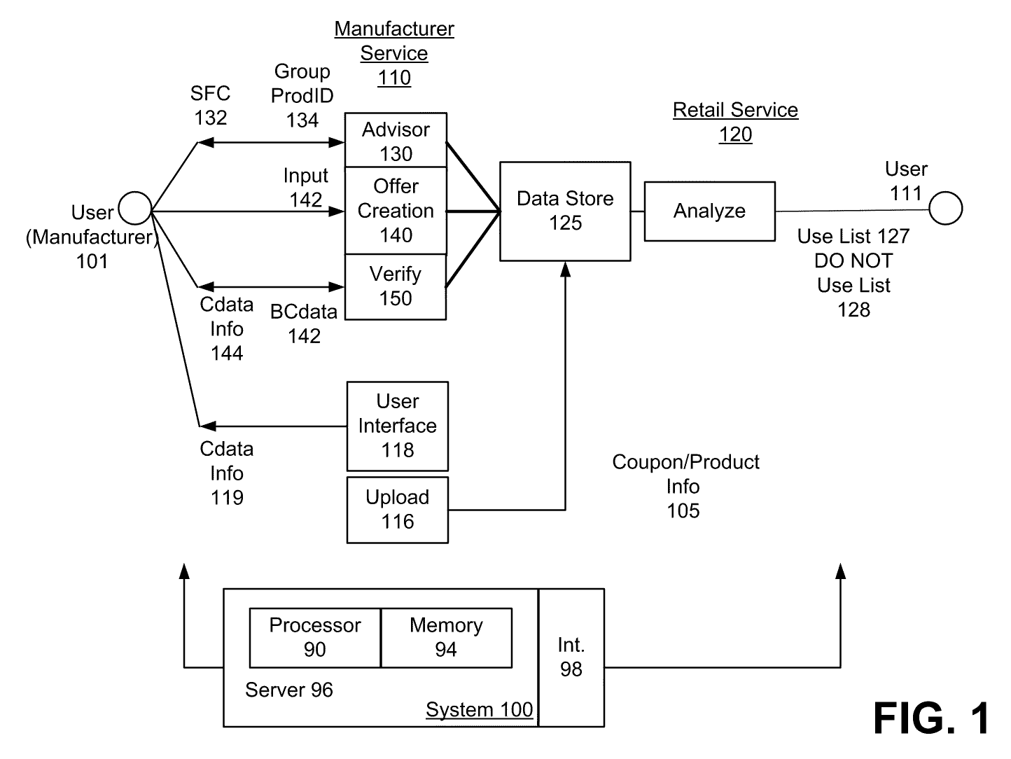

FIG. 1 illustrates a system for enabling the creation and efficient use of coupons or other transactional instruments by both manufacturers and retailers, according to one or more embodiments. In FIG. 1, the transactional instruments are depicted as a coupon, such as printed offers that consumers can redeem in stores. However, embodiments described with FIG. 1 may apply to other forms of transactional instruments, such as gift (or loyalty) cards.

In FIG. 1, system 100 includes features for both manufacturer service 110 and retail service 120. Components of the manufacturer service 110 and retail service 120 interact with a coupon data store system 125. The data store system 125 may correspond to, for example, a database system or collection of data stores that stores information 128 about both coupons and products. According to embodiments, system 100 may be implemented by a combination of processor(s) 90 and memory 94, running on a machine such as a server or set of servers. In an embodiment, a server system 96 is used to implement system 100. The server system 96 may provide a secure website accessible by terminals of different classes of users to access account information and/or view information for coupon offers and campaigns. One or more network interfaces 98 may be included with server system 96 to enable accessibility of the system 100 by users that are manufacturers/suppliers and retailers. As mentioned elsewhere, the data store 125 may be implemented as a database system (or other data storage). As an alternative, an embodiment of FIG. 1 may be implemented on other computing platforms, such as client-based systems or peer-networks.

The coupon and product information 105 of data store system 125 may originate from (i) suppliers or manufacturers, who use the data store system to create coupon offers, and (ii) third party sources that share coupon information from other manufacturers or suppliers. Thus, each coupon manufacturer who uses system 100 may supply some of the coupon/product information 105 that is in turn made available as part of the retail service 120. The coupon/product information 105 may include, for example, information about the manufacturer's products, brands, sub-brands, categories, existing coupons and offers, UPC's of products, and prior associated family codes. Other information, including lists of product items that are subject (or not subject) to coupon offers may also be made available as part of the retail service 120.

In one implementation, an upload process or component 116 enables the manufacturer users 101 of system 100 to enter their coupon and product information (for their account on system 100) in bulk, for subsequent use, modification and maintenance. While an embodiment of FIG. 1 assumes that data store 125 is an integrated element of system 100, other implementations may incorporate the data store (or portions thereof) as an external component of system 100. For example, some or all of the data store 125 may be maintained by a third party service and accessible to the components of the manufacturer and retail services 110, 120 from over a network such as the Internet. Moreover, the data store 125 may include more than one data store or source and may be distributed at multiple sites and/or amongst multiple providers.

Additionally, an embodiment provides that system 100 is web or network enabled, so that its users are able to access its features over the Internet. On the manufacturer side, the user 101 of the system 100 includes coupon manufacturers, such as manufacturers or enterprises in charge of coupon promotions. On the retail side, the user 111 of system 100 may correspond to retailers, although functionality provided for retail service 120 may be accessible to the manufacturer class of users as well.

In an embodiment, the manufacturer service 110 is comprised of modules and/or components that include coupon advisor 130, offer creation component 140, and verification 150. System 100 may be accessible to the user 101 via the secure website to enable the manufacturer to upload or enter product/coupon information 105. With an account, the manufacturer is able to use various user interfaces 118 to (i) maintain and manage its coupon/product information, (ii) create new coupon offers and update existing coupon offers.

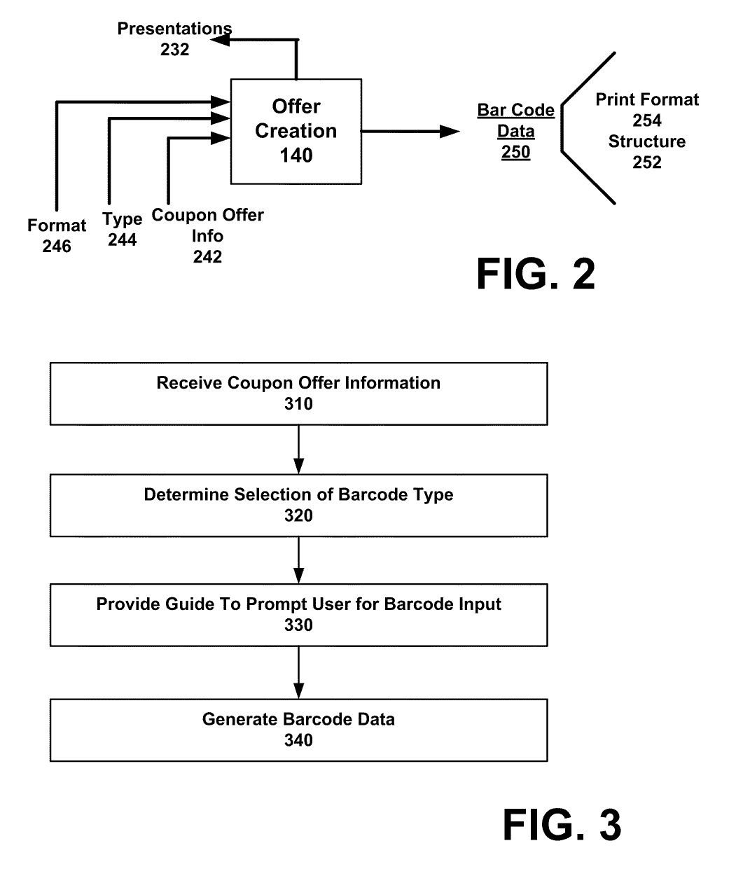

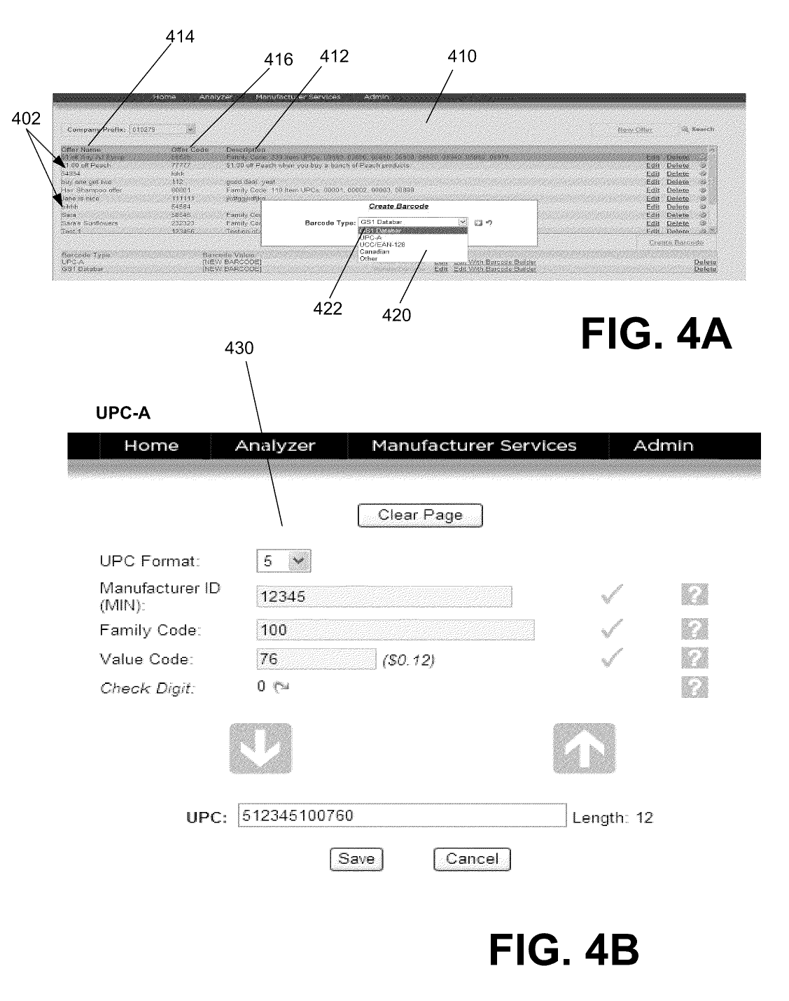

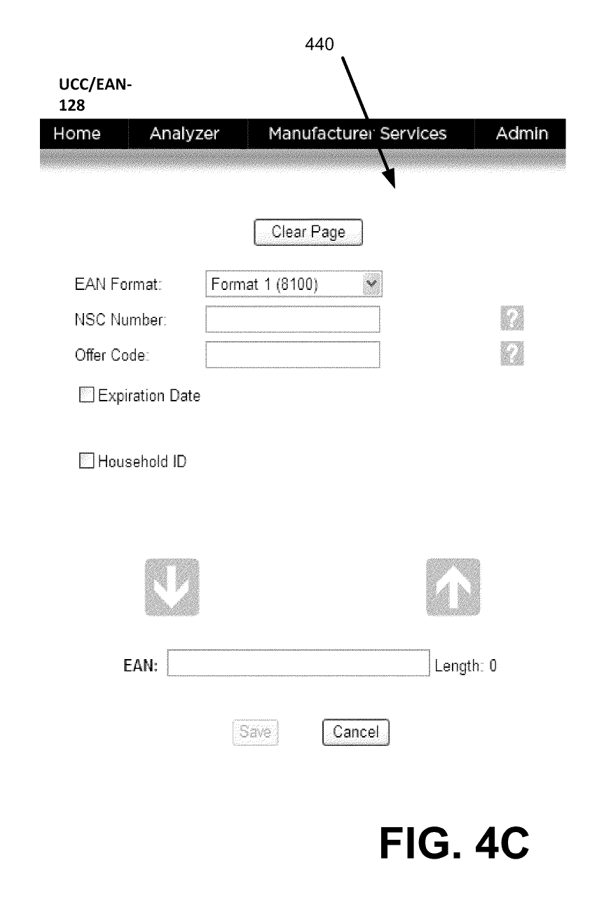

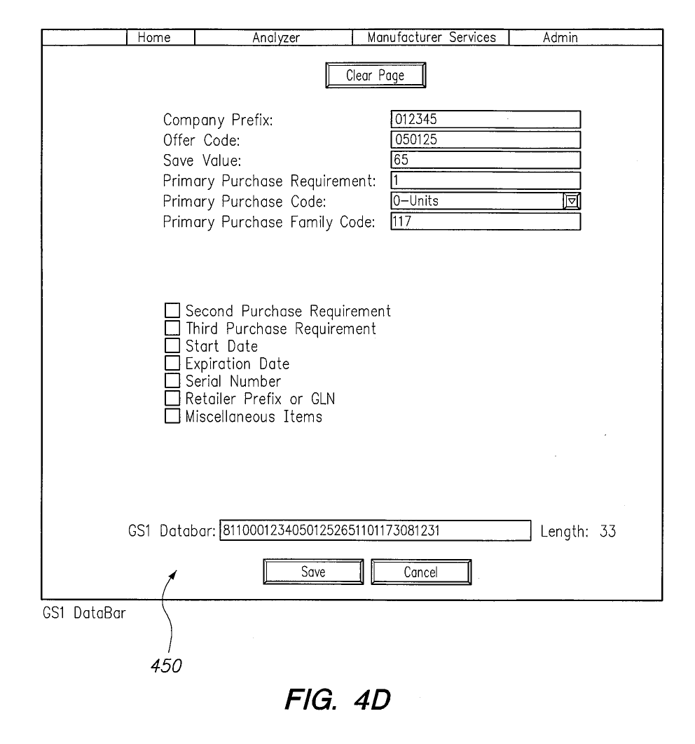

The offer creation module 140 enables the manufacturer to generate new coupon offers, including barcode data that is of a particular type selected by that user. As described with an embodiment of FIG. 2, FIG. 3 and FIG. 4A through FIG. 4D, offer creation 140 operates in connection with one or more interfaces to facilitate the creation of coupon offers (and respective barcode data). Among other benefits, the use of interfaces enables the manufacturer to create coupon offers without advanced knowledge or expertise on the structure and requirements of coupons and barcodes.

According to one or more embodiments, offer creation module 140 executes processes to assist the user in creating barcodes in anyone of many different possible formats. These formats include, for example, UPC-A, including the 99 Do Not Double, UCC/EAN-128, and GS1 DataBar. In an embodiment, the offer creation 140 includes interfaces that guide the user to enter values or parameters in accordance with the selected barcode standard. Additionally, the offer creation 140 is operable to enable the user to specify (with input parameters 142) the manner in which the coupon and/or the barcode is to be printed. For example, the user 101 (manufacturer) may specify through offer creation 140 that the coupon is to be printed in bitmap (typically having low resolution) or vector based formats (high resolution).

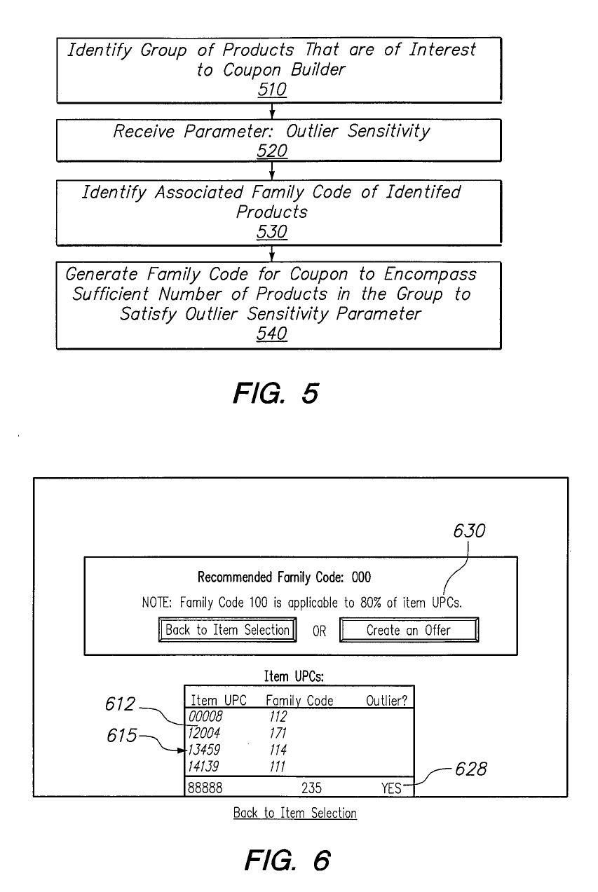

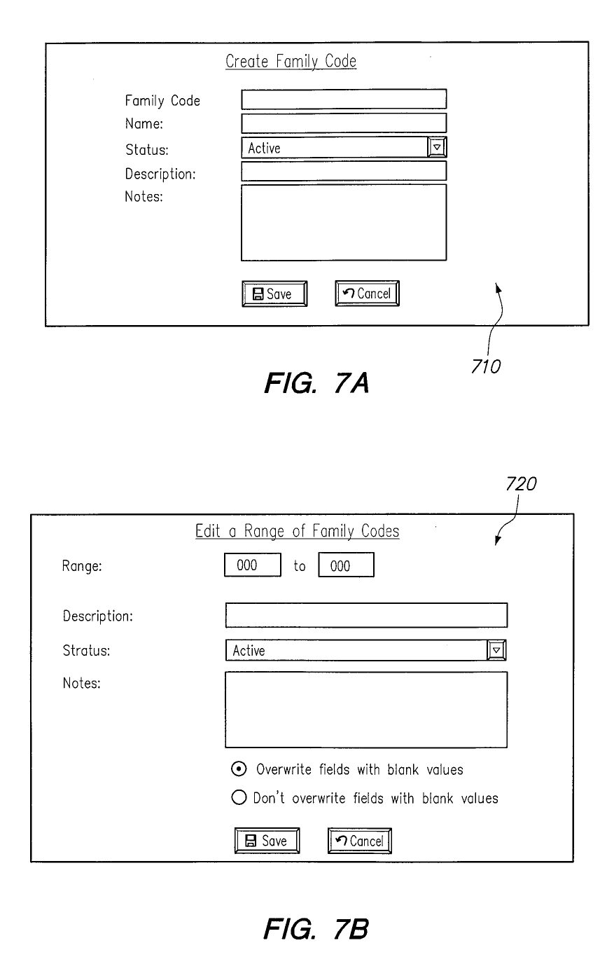

In addition to facilitating offer creation, manufacturer service 110 provides the advisor module 130 to aid the user in creating the family code for coupon offers. An embodiment of FIG. 5 and FIG. 6 illustrate functionality that may be included as part of coupon advisor 130. In particular, the coupon advisor 130 may be operated to generate a recommended family code 132 for a group of products, as identified by input 134 of user 101. The recommended family code 132 may be based on associated family codes of the individual products in the group. In an embodiment, the advisor 130 includes an interface to guide or prompt the user to identify products and enter other information for suggesting the multi-product family code. Among other benefits, the advisor module 130 provides an interface by which the manufacturer is able to receive a programmatically generated multi-product family code based on associated family codes of the individual products. The multi-product family code is generated for the user without requirement for the user to understand the rules and requirements of family codes or the selected barcode type.

In addition to coupon offers and family code recommendations, separate user interfaces 118 may be provided to enable the user to manage (view, edit, delete, create) the manufacturer's coupon related information 119. This information may include family codes that are actively or inactively in use. Among other features, the user may (i) view and maintain UPC information, including family codes assigned to UPC items, and (ii) view and manage brand/category designations, particularly in the context of family code assignments.

According to an embodiment, the verification component 150 enables the user 111 to check the values and transaction information of a coupon by inputting barcode data. In one implementation, the manufacturer user 101 enters the barcode data 142 (e.g. an actual barcode) and is returned coupon information 144 that displays the manufacturer ID, the family code, the value code and other information about the coupon. The user 101 is able to check coupon offers and related information before coupon campaigns are launched. This functionality may be shared in part by the retail service 120 (e.g. see analyzer 126).

As mentioned, system 100 may also include retail service 120. Retail service 120 may be network or web enabled to enable individual retail users to check or confirm information in coupons. In one embodiment, the retail service 120 includes analyzer 126 to (i) display and verify information that is presented with a coupon offer, and (ii) print a coupon use list 127 for a particular coupon offer (e.g. by family codes) or set or cluster of family codes. As an addition or alternative to the coupon use list 127, the retailer 111 may request from the system 100 a DO NOT use list 128. The do not use list 128 may be specific to individual family codes or coupon offers, to a given manufacturer, or to other classifications. Such DO NOT use list 128 may identify to the retailer products that are to be excluded from coupon offers, including from coupon offers from a specific manufacturer or other classification.

Structuring Coupon Offers and Corresponding Barcodes

FIG. 2 illustrates use of offer creation module 140, according to an embodiment. As previously mentioned, the offer creation component 140 enables the manufacturer to specify information for a coupon offer. According to one or more embodiments, this information includes the type of barcode or coupon offer, as well as the print format of the coupon offer.

In an embodiment, offer creation 140 operates to generate one or more presentations 232 that guide the user into entering information for specifying/defining the coupon offer and the barcode type. The user is enabled to specify information by selecting options and/or inputting natural language information. Thus, under an embodiment, user 101 (manufacturer) is not required to have advanced knowledge of coupon offer structuring. Information that is entered by the user may include, for example, (i) barcode type identification 244, (ii) print format identification 246, and (iii) coupon offer information 248. From this information, the coupon offer component 140 generates the barcode data 250, which may be used at a subsequent time to generate a coupon offer. The resulting barcode data 250 may be characterized by barcode structure 252 and print format 254.

FIG. 3 illustrates a method for creating coupon offers, under an embodiment. In describing a method of FIG. 3, reference may be made to elements described with other figures for purpose of illustrating suitable elements (offer creation module 140) for performing a step or sub-step being described.

In step 310, offer creation module 140 receives coupon offer information. The coupon offer information may include (i) a name of a coupon offer, (ii) a description of the coupon offer information, (iii) an offer code (which numerically identifies the offer for the manufacturer). Other information includes identification of the products or items that are to be made subject to the coupon offer. For example, this identification may be done by the user specifying products by UPC, by brand, sub-brand, category or other classification.

In step 320, offer creation 140 receives or determines selection by the user of a barcode type. Multiple types of barcode types exist, and each requires the user to enter some information that is specific to that type. Barcode types defined by industry standard include (i) UPC-A, (ii) UCC/EAN-128, or (iii) GS1 DataBar. Other barcode types include Canadian barcodes, or special format barcodes (these are often retailer specific).

In step 330, the user is provided an interface to enable the user to enter input for creating a barcode of the selected type. The interface may serve as a guide, in that it includes features for the user to select fields and parameters to define much of the information necessary for the barcode of the selected type. FIG. 4C through FIG. 4E illustrate how barcode input requires some information or input that is specific to the type of barcode.

Step 340 provides that data for generating barcodes in connection with the user's coupon offer is generated and stored (e.g. on the data store 150). This data may be generated and stored so that it can be printed (optionally in a format preselected by the user) with the barcode structured so that its use at a retailer site will be correctly and accurately processed.

FIG. 4A illustrates a presentation 410 in which a user is enabled to create offers 402 by including information for a description field 412, an offer name field 414, and a offer code field 416. The user may select to proceed with forming the coupon offer (e.g. select an entry to create a barcode) in which case another presentation 420 may be presented that has the user select one of multiple possible barcode types for the coupon offer.

FIG. 4B through FIG. 4E illustrate interfaces for the user to enter barcode information (corresponding to the user's coupon offer) for different kinds of barcodes. In FIG. 4B, presentation 430 is rendered for the manufacturer to enter/select barcode information for UPC-A type barcodes. Accordingly, presentation 430 may provide for the manufacturer to enter information for the following fields: (i) select “5” or “99”; (ii) enter manufacturer ID (“MIN”); (iii) family code (which may be determined programmatically, as described with some embodiments herein); (iv) value code; and (v) UPC (or product identification).

In FIG. 4C, presentation 440 is rendered for the manufacturer to enter/select barcode information for UCC-EAN type barcodes. Accordingly, presentation 440 may provide for the manufacturer to enter information for the following fields: (i) EAN Format; (ii) NSC number; (iii) offer code; (iv) expiration date; (v) household ID; and (vi) product identification information.

In FIG. 4D, presentation 450 is rendered for the manufacturer to enter/select barcode information for GS1 Databar type barcodes. Accordingly, presentation 450 may provide for the manufacturer to enter information for the following fields: (i) company prefix; (ii) offer code; (iii) save value; (iv) primary purchase requirement; (v) primary purchase code; (vi) primary purchase family code; and various other optional fields. Barcodes of GS1 Databar in particular may vary in time to include more information about products and/or coupon offers.

FIG. 4A through FIG. 4E illustrate interfaces that enable the user to enter all the necessary information to accurately create coupon offers without requiring the user (manufacturer) to have pre-existing knowledge of coupon structures and barcode types. Rather, presentations such as depicted by embodiments of FIG. 4A through FIG. 4E serve to guide the user through the otherwise complicated process of generating coupon offers and corresponding barcodes.

Recommended Family Code Generation

As mentioned, embodiments described herein provide a programmatic mechanism to recommend or suggest a family code for use with a coupon offer that encompasses a group of products, where the individual products of the group have separate and existing associations with one or more other family codes. FIG. 5 illustrates a method for generating such a recommended family code, under an embodiment. In describing an embodiment of FIG. 5, reference may be made to elements described with other figures (e.g. advisor 130 of FIG. 1) for purpose of illustrating suitable elements for performing a step or sub-step being described.

In step 510, advisor module 510 identifies a group of products that are of interest to a manufacturer for use with a coupon offer. The identification made by advisor module may be made through user input or interaction with one or more presentations (such as rendered through the user-interface component 118). For example, the manufacturer may identify the products from a list using the UPC of the individual products. Alternatively, the manufacturer may select the products in the group by brand, sub-brand or category designation.

In step 520, the user (manufacturer) enters a parameter that indicates the acceptable minimum percentage of products in the identified group that are to be covered under a single family code. As an example, the percentage may be 80-95%, meaning that the user can select the parameter (so called “outlier parameter”) when it is acceptable for the family code to encompass (i) at least the percentage (corresponding to the outlier parameter) of products in the group of products of interest, (ii) but less than all of the products in the identified group of interest.

In step 530, a recommended family code is generated based on (i) the associated family codes of the products in the group, and (ii) the outlier parameter. A non-descript or generic family code is used to cover 100% of the products of interest (as well as all other products that have family codes for the manufacturer) if no other family code can be determined that satisfies the outlier parameter. Step 540 provides that a family code is generated for the coupon offer to encompass a sufficient number of products in the group to satisfy the outlier sensitivity parameter.

The following provides an example where five products comprise the group of interest, and where only 80% of the products in the group have associated family codes that can be encompassed by a suggested family code other than “000”. The family codes of the products of interest are:

| | |
|---|---|
| Item 1 | 111 |
| Item 2 | 112 |
| Item 3 | 113 |
| Item 4 | 114 |
| Item 5 | 310 |

In the example provided, if the outlier parameter is 80%, then a recommended family code for the set is 110, based on family code generation rules. The family code generation rules for a group of products may include:

(i) if acceptable percentage (as defined by outlier sensitivity parameter) of products in the group have the same family code, then that family code is the suggested family code for the items in the group, excluding the products outside of the outlier sensitivity;

(ii) else use “0” (which is a family code wildcard) as the right most numeral of each family code in the group;

(iii) if acceptable percentage (as defined by outlier sensitivity parameter) of products in the group now have the same family code (when the newly added wildcard is considered), then the recommended family code is “XY0” (excluding the products outside of the outlier sensitivity) where X and Y are the two digits that are the same for the acceptable number of products in the group;

(iv) else use “00” as the first two numerals (counting from right to left)of each family code in the group to make those two numbers wildcards;

(v) if acceptable percentage (as defined by outlier sensitivity parameter) of products in the group now have the same family code (when the two wildcards are considered), then the recommended family code of the group is (“X00”) (excluding the products outside of the outlier sensitivity) where X is the far left digit that is shared by the products in the group;

(vi) Otherwise the family code is “000”.

In the case where the recommended family code for the group is “000”, the user may be notified of that fact before the recommended family code is assigned. As more wildcards are included in the family code, the more likely unintended products from the group will also be encompassed in the family code.

FIG. 6 illustrates a presentation in which a recommended family code is suggested to the user, such as described with an embodiment of FIG. 5. More specifically, FIG. 6 illustrates a group of products 615 identified by UPC 612 which have associated family codes from which the recommended family code is to be generated. An outlier designation value 628 may be associated with one or more of the products. At least one (and possibly more) family code that can be shared by two or more of the products is identified. Other products that have family codes falling outside of the determined shared family code are identified by the outlier designation value 628. The determined family code is used if it is shared by a sufficient number of products to satisfy the outlier sensitivity parameter specified by the user. If no determined family code is shared by a sufficient number of products to satisfy the outlier sensitivity parameter, “000” (all wildcard) is used. However, as indicated by the example of FIG. 6, a suggestion 630 for an alternative family code may be made if one of the determined family codes encompasses a large majority (e.g. 80% or more) of the family codes. The user may select or designate the family code for the group of products and then proceed to creating a coupon offer for the group of products.

Among other benefits, embodiments such as described with FIG. 5 and FIG. 6 recognize that a suggested family code to encompass multiple products with existing family codes is often not possible unless the family code is chosen to be a generic (“000”) or non-descript family code. Such generic family codes encompass all products of the manufacturer ID, and may be overreaching to the manufacturer. But as described with embodiments of FIG. 5 and FIG. 6, a single suggested family code may be generated that encompasses a large percentage of products of interest, if not all. This percentage (e.g. 80%) may be acceptable to the user. Rather than foregoing the possibility of having a multi-item family code because of a small percentage of products that have incompatible associated family codes, an embodiment such as described identifies the products with the incompatible family codes and suggests their removal from the user's selection. This allows the user to use a recommended family code that encompasses family codes of a large (and acceptable) percentage of products in the user's selected group.

Other Interfaces for Managing Offers and Related Information

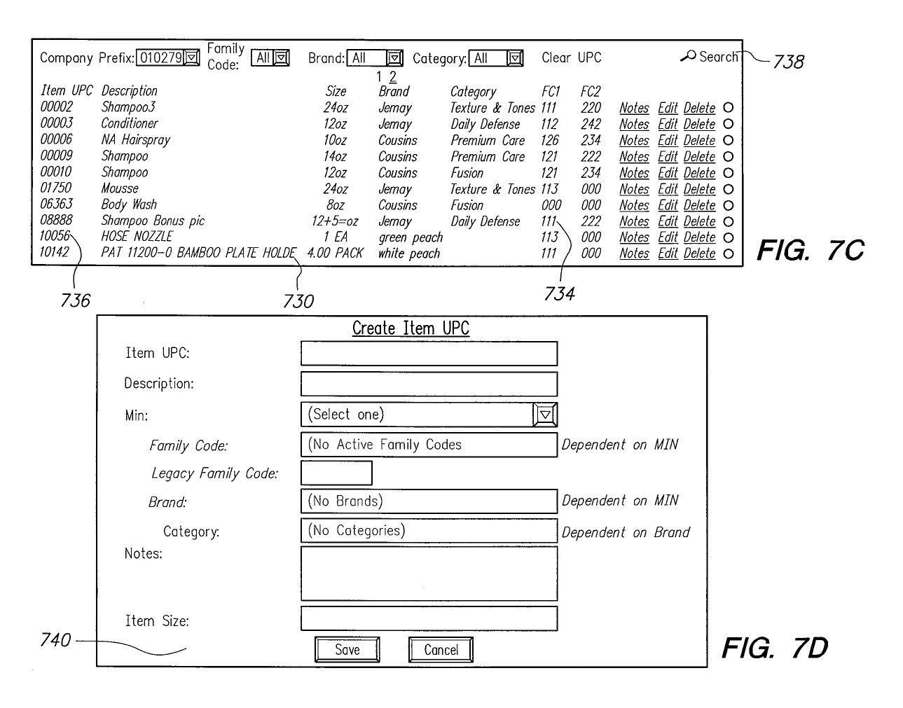

FIG. 7A through FIG. 7E illustrate various family code related interfaces that may be generated from a system such as described with FIG. 1, under an embodiment. In particular, interfaces depicted by FIG. 7A through FIG. 7E are illustrative of the type of interfaces that can be created using the user interface 118.

With reference to FIG. 7A, an interface 710 may be generated (e.g. as a web page) for a user to create a family code. The interface 710 may be rendered for the user in response to the user selecting to have a new family code defined on the user's account. The user may simply enter information in the fields for the family code, the identification (e.g. UPC) of the product or products encompassed by the family code, a brief description of those products, and other notes that the user can subsequently use to maintain the family code information.

FIG. 7B illustrates an interface 720 for editing the family code, under an embodiment. The family code may be edited individually or by range. When edited by range, one user edit may apply to all of the family codes on the user's account that fit that range. Thus, a user may enter a note one time for a given range of family codes, then have that note associated with the family codes in the designated range for future use. For example, the user may edit family codes that are active or in use, as well as those that are inactive (not in use). The user may also move family codes between active and inactive status.

FIG. 7C illustrates a UPC maintenance interface 730 for use with managing family codes and coupon offers/campaigns, under an embodiment. The maintenance interface 730 displays UPC items for a specific manufacturer (as identified by the company prefix in company prefix field 732) along with the family codes 734 assigned to the specific UPC items 736. Descriptions, brands, notes and other information entered through other interfaces (such as the interface 710) may be carried over to be shown in the interface 730. In one implementation, a search feature 738 is provided that enables a user to search for family code and coupon information related to a specific UPC.

FIG. 7D illustrates an interface 740 for creating a UPC in association with a family code, under an embodiment. To create a new UPC, the user may interact with interface 740 by selecting the appropriate company prefix, then filling in the appropriate fields. In an implementation such as shown, the fields include (i) Item UPC—A unique number specific to an item (Item UPCs are associated with a specific Company Prefix); (ii) Description; (iii) MIN—the Company Prefix for the item (shown provided from a drop-down list); (iv) Family Code—(if family code has not been created, it will need to be created); (v) Legacy Family Code or Family Code 2; (vi) Brand; (vi) Category-(category may be dependent on brand); and (vii) Size—the size of the item. An interface such as shown by FIG. 2D may also be used to change a family code assignment to an item, or to add a second or new family code assignment. Values for the fields of brand and category may be defined through other interfaces. Each category may correspond to a sub-brand. The use of brand or sub-brands/categories enables the manufacturer user to more readily select a family code manually for a given set of products.

FIG. 7E illustrates an interface 750 for creating a coupon offer, according to an embodiment. As shown, interface 750 may guide the user into entering information (via corresponding fields) that (i) identifies a coupon offer by name and code, (ii) short text description, (iii) a family code for the coupon offer, (iv) a value of the coupon offer, and (v) an expiration date of the coupon offer. The manufacturer can also designate the active/inactive status of the coupon offer. In the implementation shown, the manufacturer can create a barcode for the coupon offer, and navigate or use additional features to enter UPC information. The family code for a product of a coupon offer can form the basis of a new family code, such as described with other embodiments (see FIG. 5) in which a multi-product family code coupon offer is generated.

Retail Service

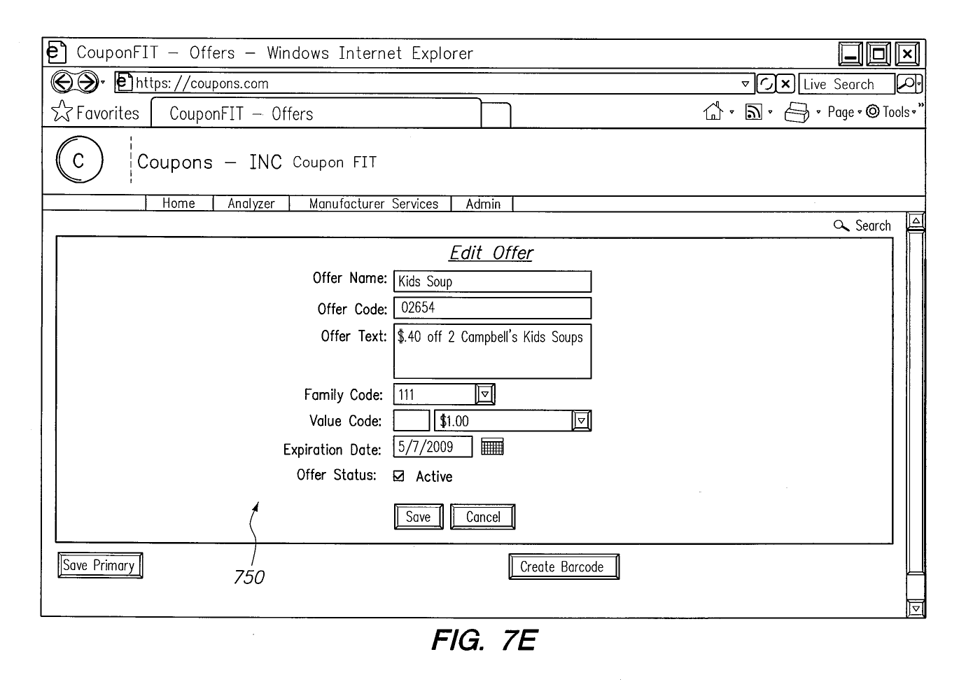

FIG. 8 illustrates analyzer 126 for providing retail service functionality using information maintained in the data store system 125 (FIG. 1). The analyzer 126 may be responsive to queries or input requested from retail user 111 (FIG. 1). According to one or more embodiments, the analyzer 126 may be operated to provide information about specific coupon offer(s), or provide information in batch or lists about products of manufacturers.

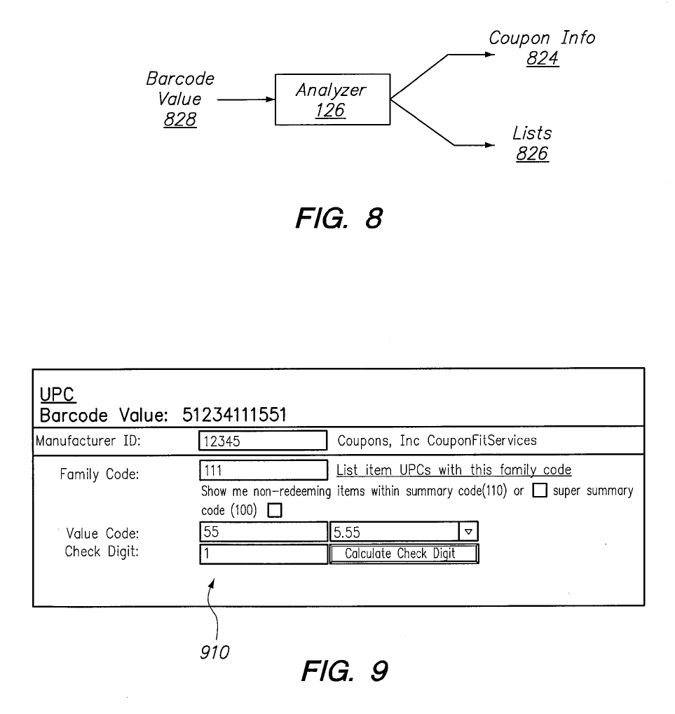

In one mode of operation, the retail user 111 enters a barcode value 828 from a coupon offer to, for example, validate a transaction in which the consumer attempts to use the coupon offer. The retailer may simply scan the barcode or enter its numerical information. The analyzer 126 may query the data store 125 (FIG. 1) using the barcode value 828 in order to determine information about the coupon offer. This information is depicted as a coupon record 910 in an embodiment of FIG. 9. The coupon record 910 identifies the manufacturer, and the product(s) (by UPC or otherwise) that are subject to the coupon offer. In the example provided, the information that is electronically displayed includes the coupon value code, the family code and the check digit.

In addition to information 822 about individual coupon offers, batch lists 826 may be sent to retailers from data store 125 to identify whether products are (or are not) to be subject to coupon offers. Such batch lists may be generated for the retailer based on a specified manufacturer, family code, brand, product class or other classification. An approved product list may enable the retailer to establish an onsite automated mechanism where the coupon offers that include a product from the product list are automatically or more readily approved. A DO NOT use list, conversely, may be provided from system 100 as a mechanism to ensure that the retailer's automation equipment does not accidently honor a coupon offer that is expired, incorrect, or recalled. The Do NOT use list may also clarify when products are to not be subject to coupon offers, such as in instances when the image on a coupon offer seems to encompass other than the product(s) identified from the barcode. As an alternative to the use/DO NOT use lists, one or more embodiments may list coupons that are “buy one, get one free”. The retailer can use such a list to notify the consumer that they can purchase another item for free. Any of the lists provided from system 100 may be provided to the retailer independent of the retailer supplying coupon information or requiring validation at the time a transaction is taking place.

Alternatives

While numerous embodiments described herein have particular applicability to coupon offers, concepts and functionality described herein may be equally applicable to other transactional instruments such as loyalty or gift cards. Such instruments may include (i) barcodes that are formatted or structured in one of the many formats described herein (or alternative formats), (ii) be designed and associated with products or items using interfaces such as described herein.

### CONCLUSION

Although illustrative embodiments of the invention have been described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mentioned of the particular feature. Thus, the absence of describing combinations should not preclude the inventor from claiming rights to such combinations

1. A system for creating coupon offers, the system comprising: one or more modules configured to:
enable a user to create a coupon offer;
enable a user to select a barcode type from a plurality of possible barcode types;
display an interface that is specific to the barcode type, wherein the interface includes one or more fields that guide the user to provide one or more inputs;
generate data for a barcode of the selected barcode type, using information that is determined from the one or more inputs.

2. The system of claim 1, the one or more modules are configured to enable the user to select a print format for the barcode.

3. The system of claim 2, wherein the one or more modules are configured to enable the user to select the print format that corresponds to one of a vector based format or a bit map format.

4. The system of claim 1, wherein the one or more modules are configured to enable the user to create the coupon offer by presenting the user an interface to enter information corresponding to (i) an offer name, (ii) an offer code, and/or (iii) an offer description.

5. The system of claim 4, wherein the one or more modules are configured to enable the user to create the coupon offer by enabling the user to specify one or more products that are to be included in the offer.

6-8. (canceled)

9. The system of claim 1, wherein the one or more modules enable a user to select the barcode type that corresponds to one of (i) UPC-A, (ii) UCC/EAN-128, or (iii) GS1 DataBar.

10. The system of claim 1, wherein the one or more modules enable a user to select the barcode type that corresponds to a special barcode or a Canadian barcode.

11. The system of claim 1, wherein the one or more modules display one or more web pages with predetermined input fields in order to enable the user to enter information to create the coupon offer and to select the barcode type.

12. A method for creating coupon offers, the method being implemented by one or more processors that perform steps comprising:
enabling a user to select a barcode type from a plurality of possible barcode types;
presenting the user with an interface that is specific to the selected barcode type, wherein the interface includes one or more fields that notify the user to provide one or more inputs;
generate data for a barcode of the selected barcode type for a coupon offer that is specified by the user, the data being generated using information that is determined from the one or more inputs.

13. The method of claim 12, further comprising presenting the user with one or more interfaces to enable the user to create the coupon offer and to enable the user to select the barcode type.

14. The method of claim 12, wherein enabling the user to select the barcode type includes enabling the barcode type corresponding to one of a (i) UPC-A, (ii) UCC/EAN-128, or (iii) GS1 DataBar.

15. The method of claim 12, wherein generating data for the barcode includes generating the data to cause the barcode to have a print format that is selected by the user.

16. The method of claim 12, further comprising presenting the user with one or more interfaces that enable the user to (i) create the coupon offer, and (ii) designate one or more products that are to be included in the coupon offer.

17-20. (canceled)

21. A system for managing coupon offers, the system comprising:
one or more processors configured to:
analyze and validate any given coupon offer identified by a retailer by comparing information identified from the coupon offer to information maintained in a coupon data store; and
independent of any transaction at a location of the retailer, access the coupon data store to receive (i) a list of coupons that are valid for transactions in the location of the retailer, and (ii) a list of coupon offers that are not valid at the location of the retailer.
